(19) United States
(12) Patent Application Publication
(10) Pub. No.: US 2026/0281398 A1
(43) Pub. Date: Sep. 17, 2026

(54) METHOD AND APPARATUS OF SYNTAX DESIGN FOR CROSS-COMPONENT MODELS IN VIDEO CODING SYSTEM

(71) Applicant: MEDIATEK INC., Hsinchu City (TW)

(72) Inventors: Chia-Ming TSAI, Hsinchu City (TW); Cheng-Yen CHUANG, Hsinchu City (TW); Hsin-Yi TSENG, Hsinchu City (TW); Chih-Wei HSU, Hsinchu City (TW); Yi-Wen CHEN, San Jose, CA (US); Ching-Yeh CHEN, Hsinchu City (TW); Tzu-Der CHUANG, Hsinchu City (TW)

(21) Appl. No.: 19/473,437

(22) PCT Filed: Oct. 12, 2024
(86) PCT No.: PCT/CN2024/124398

§ 371 Date: Oct. 7, 2025

Related U.S. Application Data
(60) Provisional application No. 63/590,004, filed on Oct. 13, 2023.

(51) Int. Cl. H04N 19/196; H04N 19/105; H04N 19/159; H04N 19/186; H04N 19/70

(52) U.S. Cl. CPC H04N 19/196; H04N 19/105; H04N 19/159; H04N 19/186; H04N 19/70

(57) ABSTRACT

A method and apparatus for video coding are disclosed. According to this method, for a current second-colour block is coded in a cross-component Liner Model (LM)-related mode, a most probable LM mode list comprising one or more most probable LM candidates selected from a candidate list is generated. Mode-selection information associated with the most probable LM mode list is signalled or parsed. The current second-colour block is encoded or decoded by using a target candidate selected from the most probable LM mode list according to the mode-selection information, wherein prediction data for the current second-colour block is generated by applying current linear model associated with the target candidate to the current first-colour block.

### CROSS REFERENCE TO RELATED APPLICATIONS

The present invention is a Non-Provisional application of and claims priority to U.S. Provisional Patent Application No. 63/590,004, filed on Oct. 13, 2023. The U.S. Provisional Patent Application is hereby incorporated by reference in its entirety.

### FIELD OF THE INVENTION

The present invention relates to video coding. In particular, the present invention relates to schemes to improve the coding performance for video coding systems using an LM (Linear Model) mode.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

### Partitioning of the CTUs Using a Tree Structure

In HEVC, a CTU is split into CUs by using a quaternary-tree (QT) structure denoted as coding tree to adapt to various local characteristics. The decision whether to code a picture area using inter-picture (temporal) or intra-picture (spatial) prediction is made at the leaf CU level. Each leaf CU can be further split into one, two or four PUs according to the PU splitting type. Inside one PU, the same prediction process is applied and the relevant information is transmitted to the decoder on a PU basis. After obtaining the residual block by applying the prediction process based on the PU splitting type, a leaf CU can be partitioned into transform units (TUs) according to another quaternary-tree structure similar to the coding tree for the CU. One of key feature of the HEVC structure is that it has the multiple partition conceptions including CU, PU, and TU.

In VVC, a quadtree with nested multi-type tree using binary and ternary splits segmentation structure replaces the concepts of multiple partition unit types, i.e. it removes the separation of the CU, PU and TU concepts except as needed for CUs that have a size too large for the maximum transform length, and supports more flexibility for CU partition shapes. In the coding tree structure, a CU can have either a square or rectangular shape. A coding tree unit (CTU) is first partitioned by a quaternary tree (a.k.a. quadtree) structure. Then the quaternary tree leaf nodes can be further partitioned by a multi-type tree structure. As shown in FIG. 2, there are four splitting types in multi-type tree structure, vertical binary splitting (SPLIT_BT_VER 210), horizontal binary splitting (SPLIT_BT_HOR 220), vertical ternary splitting (SPLIT_TT_VER 230), and horizontal ternary splitting (SPLIT_TT_HOR 240). The multi-type tree leaf nodes are called coding units (CUs), and unless the CU is too large for the maximum transform length, this segmentation is used for prediction and transform processing without any further partitioning. This means that, in most cases, the CU, PU and TU have the same block size in the quadtree with nested multi-type tree coding block structure. The exception occurs when maximum supported transform length is smaller than the width or height of the colour component of the CU.

FIG. 3 illustrates the signalling mechanism of the partition splitting information in quadtree with nested multi-type tree coding tree structure. A coding tree unit (CTU) is treated as the root of a quaternary tree and is first partitioned by a quaternary tree structure. Each quaternary tree leaf node (when sufficiently large to allow it) is then further partitioned by a multi-type tree structure. In quadtree with nested multi-type tree coding tree structure, for each CU node, a first flag (split_cu_flag) is signalled to indicate whether the node is further partitioned. If the current CU node is a quadtree CU node, a second flag (split_qt_flag) whether it's a QT partitioning or MTT partitioning mode. When a node is partitioned with MTT partitioning mode, a third flag (mtt_split_cu_vertical_flag) is signalled to indicate the splitting direction, and then a fourth flag (mtt_split_cu_binary_flag) is signalled to indicate whether the split is a binary split or a ternary split. Based on the values of mtt_split_cu_vertical_flag and mtt_split_cu_binary_flag, the multi-type tree slitting mode (MttSplitMode) of a CU is derived as shown in Table 1.

TABLE 1
MttSplitMode derivation based on multi-type tree syntax elements

| | mtt_split_cu_{—} | mtt_split_cu_{—} |
|---|---|---|
| MttSplitMode | vertical_flag | binary_flag |
| SPLIT_TT_HOR | 0 | 0 |
| SPLIT_BT_HOR | 0 | 1 |
| SPLIT_TT_VER | 1 | 0 |
| SPLIT_BT_VER | 1 | 1 |

FIG. 4 shows a CTU divided into multiple CUs with a quadtree and nested multi-type tree coding block structure, where the bold block edges represent quadtree partitioning and the remaining edges represent multi-type tree partitioning. The quadtree with nested multi-type tree partition provides a content-adaptive coding tree structure comprised of CUs. The size of the CU may be as large as the CTU or as small as 4×4 in units of luma samples. For the case of the 4:2:0 chroma format, the maximum chroma CB size is 64×64 and the minimum size chroma CB consist of 16 chroma samples.

In VVC, the maximum supported luma transform size is 64×64 and the maximum supported chroma transform size is 32×32. When the width or height of the CB is larger the maximum transform width or height, the CB is automatically split in the horizontal and/or vertical direction to meet the transform size restriction in that direction.

The following parameters are defined for the quadtree with nested multi-type tree coding tree scheme. These parameters are specified by SPS syntax elements and can be further refined by picture header syntax elements.
CTU size: the root node size of a quaternary tree
MinQTSize: the minimum allowed quaternary tree leaf node size
MaxBtSize: the maximum allowed binary tree root node size
MaxTtSize: the maximum allowed ternary tree root node size
MaxMttDepth: the maximum allowed hierarchy depth of multi-type tree splitting from a quadtree leaf
MinCbSize: the minimum allowed coding block node size

In one example of the quadtree with nested multi-type tree coding tree structure, the CTU size is set as 128×128 luma samples with two corresponding 64×64 blocks of 4:2:0 chroma samples, the MinQTSize is set as 16×16, the MaxBtSize is set as 128×128 and MaxTtSize is set as 64×64, the MinCbsize (for both width and height) is set as 4×4, and the MaxMttDepth is set as 4. The quaternary tree partitioning is applied to the CTU first to generate quaternary tree leaf nodes. The quaternary tree leaf nodes may have a size from 16×16 (i.e., the MinQTSize) to 128×128 (i.e., the CTU size). If the leaf QT node is 128×128, it will not be further split by the binary tree since the size exceeds the MaxBtSize and MaxTtSize (i.e., 128×128). Otherwise, the leaf qdtree node could be further partitioned by the multi-type tree. Therefore, the quaternary tree leaf node is also the root node for the multi-type tree and it has multi-type tree depth (mttDepth) as 0. When the multi-type tree depth reaches MaxMttDepth (i.e., 4), no further splitting is considered. When the multi-type tree node has width equal to MinCbsize, no further horizontal splitting is considered. Similarly, when the multi-type tree node has height equal to MinCbsize, no further vertical splitting is considered.

In VVC, the coding tree scheme supports the ability for the luma and chroma to have a separate block tree structure. For P and B slices, the luma and chroma CTBs in one CTU have to share the same coding tree structure. However, for I slices, the luma and chroma can have separate block tree structures. When the separate block tree mode is applied, luma CTB is partitioned into CUs by one coding tree structure, and the chroma CTBs are partitioned into chroma CUs by another coding tree structure. This means that a CU in an I slice may consist of a coding block of the luma component or coding blocks of two chroma components, and a CU in a P or B slice always consists of coding blocks of all three colour components unless the video is monochrome.

Intra Mode Coding with 67 Intra Prediction Modes

To capture the arbitrary edge directions presented in natural video, the number of directional intra modes in VVC is extended from 33, as used in HEVC, to 65. The new directional modes not in HEVC are depicted as dotted arrows in FIG. 5, and the planar and DC modes remain the same. These denser directional intra prediction modes apply for all block sizes and for both luma and chroma intra predictions.

In VVC, several conventional angular intra prediction modes are adaptively replaced with wide-angle intra prediction modes for the non-square blocks.

In HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### Intra Mode Coding

To keep the complexity of the most probable mode (MPM) list generation low, an intra mode coding method with 6 MPMs is used by considering two available neighbouring intra modes. The following three aspects are considered to construct the MPM list:
Default intra modes
Neighbouring intra modes
Derived intra modes.

A unified 6-MPM list is used for intra blocks irrespective of whether MRL and ISP coding tools are applied or not. The MPM list is constructed based on intra modes of the left and above neighbouring block. Suppose the mode of the left is denoted as Left and the mode of the above block is denoted as Above, the unified MPM list is constructed as follows:
When a neighbouring block is not available, its intra mode is set to Planar by default.
If both modes Left and Above are non-angular modes:
   MPM list→{Planar, DC, V, H, V−4, V+4}
If one of modes Left and Above is angular mode, and the other is non-angular:
   Set a mode Max as the larger mode in Left and Above
   MPM list→{Planar, Max, Max−1, Max+1, Max−2, M+2}
If Left and Above are both angular and they are different:
   Set a mode Max as the larger mode in Left and Above
   If Max-Min is equal to 1:
      MPM list→{Planar, Left, Above, Min−1, Max+1, Min−2}
   Otherwise, if Max-Min is greater than or equal to 62:
      MPM list→{Planar, Left, Above, Min+1, Max−1, Min+2}
   Otherwise, if Max-Min is equal to 2:
      MPM list→{Planar, Left, Above, Min+1, Min−1, Max+1}
   Otherwise:
      MPM list→{Planar, Left, Above, Min−1, −Min+1, Max−1}
If Left and Above are both angular and they are the same:
   MPM list→{Planar, Left, Left−1, Left+1, Left−2, Left+2}

Besides, the first bin of the MPM index codeword is CABAC context coded. In total three contexts are used, corresponding to whether the current intra block is MRL enabled, ISP enabled, or a normal intra block.

During 6 MPM list generation process, pruning is used to remove duplicated modes so that only unique modes can be included into the MPM list. For entropy coding of the 61 non-MPM modes, a Truncated Binary Code (TBC) is used.

### Wide-Angle Intra Prediction for Non-Square Blocks

Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged.

To support these prediction directions, the top reference with length 2W+1, and the left reference with length 2H+1, are defined as shown in FIG. 6A and FIG. 6B respectively.

The number of replaced modes in wide-angular direction mode depends on the aspect ratio of a block. The replaced intra prediction modes are illustrated in Table 2.

TABLE 2
Intra prediction modes replaced by wide-angular modes

| Aspect ratio | Replaced intra prediction modes |
|---|---|
| W/H == 16 | Modes 12, 13, 14, 15 |
| W/H == 8 | Modes 12, 13 |
| W/H == 4 | Modes 2, 3, 4, 5, 6, 7, 8, 9, 10, 11 |
| W/H == 2 | Modes 2, 3, 4, 5, 6, 7, |
| W/H == 1 | None |
| W/H == ½ | Modes 61, 62, 63, 64, 65, 66 |
| W/H == ¼ | Mode 57, 58, 59, 60, 61, 62, 63, 64, 65, 66 |
| W/H == ⅛ | Modes 55, 56 |
| W/H == 1/16 | Modes 53, 54, 55, 56 |

In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below −135° and above 45°, luma intra prediction modes ranging from 2 to 5 are mapped to 2. Therefore, chroma DM derivation table for 4:2:2: chroma format is updated by replacing some values of the entries of the mapping table to convert prediction angle more precisely for chroma blocks.

### Cross-Component Linear Model (CCLM) Prediction

To reduce the cross-component redundancy, a cross-component linear model (CCLM) prediction mode is used in the VVC, for which the chroma samples are predicted based on the reconstructed luma samples of the same CU by using a linear model as follows:

$${pred}_{C} ( i , j ) = α \cdot r e {c}_{L}^{′} ( i , j ) + β \qquad ( 1 )$$

where pred_{C}(i, j) represents the predicted chroma samples in a CU and rec_{L}′(i, j) represents the downsampled reconstructed luma samples of the same CU.

The CCLM parameters (a and B) are derived with at most four neighbouring chroma samples and their corresponding down-sampled luma samples. Suppose the current chroma block dimensions are W×H, then W′ and H′ are set as
W′=W, H′=H when LM_LA mode is applied;
W′=W+H when LM_A mode is applied;
H′=H+W when LM_L mode is applied.

The above neighbouring positions are denoted as S[0, −1] . . . . S[W′−1, −1] and the left neighbouring positions are denoted as S[−1, 0] . . . . S[−1, H′−1]. Then the four samples are selected as
S[W′/4, −1], S[3*W′/4, −1], S[−1, H′/4], S[−1, 3*H′/4] when LM mode is applied and both above and left neighbouring samples are available;
S[W′/8, −1], S[3*W′/8, −1], S[5*W′/8, −1], S[7*W′/8, −1] when LM-A mode is applied or only the above neighbouring samples are available;
S[−1, H′/8], S[−1, 3*H′/8], S[−1, 5*H′/8], S[−1, 7*H′/8] when LM-L mode is applied or only the left neighbouring samples are available.

The four neighbouring luma samples at the selected positions are down-sampled and compared four times to find two larger values: x0A and x1A, and two smaller values: x0B and x1B. Their corresponding chroma sample values are denoted as y0A, y1A, yOB and y1B. Then XA, xB, yA and yB are derived as:

$$Xa = ( x 0 A + x 1 A + 1 ) >> 1 ; \qquad ( 2 )$$

$$Xb = ( x 0 B + x 1 B + 1 ) >> 1 ;$$

$$Ya = ( y 0 A + y 1 A + 1 ) >> 1 ;$$

$$Yb = ( y 0 B + y 1 B + 1 ) >> 1$$

Finally, the linear model parameters a and B are obtained according to the following equations.

$$α = \frac{{Y}_{a} - {Y}_{b}}{{X}_{a} - {X}_{b}} \qquad ( 3 )$$

$$β = {Y}_{b} - α \cdot {X}_{b} \qquad ( 4 )$$

FIG. 7 shows an example of the location of the left and above samples and the sample of the current block involved in the LM_LA mode. FIG. 7 shows the relative sample locations of N×N chroma block 710, the corresponding 2N×2N luma block 720 and their neighbouring samples (shown as filled circles).

The division operation to calculate parameter a is implemented with a look-up table. To reduce the memory required for storing the table, the diff value (difference between maximum and minimum values) and the parameter a are expressed by an exponential notation. For example, diff is approximated with a 4-bit significant part and an exponent. Consequently, the table for 1/diff is reduced into 16 elements for 16 values of the significand as follows:

$$DivTable [ ] = \{ 0 , 7 , 6 , 5 , 5 , 4 , 4 , 3 , 3 , 2 , 2 , 1 , 1 , 1 , 1 , 0 \} \qquad ( 5 )$$

This would have a benefit of both reducing the complexity of the calculation as well as the memory size required for storing the needed tables.

Besides the above template and left template can be used to calculate the linear model coefficients together, they also can be used alternatively in the other 2 LM modes, called LM_A, and LM_L modes.

In LM_A mode, only the above template is used to calculate the linear model coefficients. To get more samples, the above template is extended to (W+H) samples. In LM_L mode, only left template are used to calculate the linear model coefficients. To get more samples, the left template is extended to (H+W) samples.

In LM_LA mode, left and above templates are used to calculate the linear model coefficients.

To match the chroma sample locations for 4:2:0 video sequences, two types of down-sampling filter are applied to luma samples to achieve 2 to 1 down-sampling ratio in both horizontal and vertical directions. The selection of down-sampling filter is specified by a SPS level flag. The two down-sampling filters are as follows, which are corresponding to “type-0” and “type-2” content, respectively.

$$Re {c}_{L}^{′} ( i , j ) = [ re {c}_{L} ( 2 i - 1 , 2 j - 1 ) + 2 \cdot {rec}_{L} ( 2 i - 1 , 2 j - 1 ) + r e {c}_{L} ( 2 i + 1 , 2 j - 1 ) + {rec}_{L} ( 2 i - 1 , 2 j ) + 2 \cdot {rec}_{L} ( 2 i , 2 j ) + r e {c}_{L} ( 2 i + 1 , 2 j ) + 4 ] ≫ 3 \qquad ( 6 )$$

$$Re {c}_{L}^{′} ( i , j ) = r e {c}_{L} ( 2 i , 2 j - 1 ) + r e {c}_{L} ( 2 i - 1 , 2 j ) + 4 \cdot {rec}_{L} ( 2 i , 2 j ) + r e {c}_{L} ( 2 i + 1 , 2 j ) + re {c}_{L} ( 2 i , 2 j + 1 ) + 4 ] ≫ 3 \qquad ( 7 )$$

Note that only one luma line (general line buffer in intra prediction) is used to make the down-sampled luma samples when the upper reference line is at the CTU boundary.

This parameter computation is performed as part of the decoding process, and is not just as an encoder search operation. As a result, no syntax is used to convey the a and B values to the decoder.

For chroma intra mode coding, a total of 8 intra modes are allowed for chroma intra mode coding. Those modes include five traditional intra modes and three cross-component linear model modes (LM_LA, LM_A, and LM_L). Chroma mode signalling and derivation process are shown in Table 3. Chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the center position of the current chroma block is directly inherited.

TABLE 3
Derivation of chroma prediction mode
from luma mode when cclm_is enabled

| | Corresponding luma intra prediction mode | | | | |
|---|---|---|---|---|---|
| Chroma prediction mode | 0 | 50 | 18 | 1 | X (0 <= X <= 66) |
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 0 | 50 | 18 | 1 | X |
| 5 | 81 | 81 | 81 | 81 | 81 |
| 6 | 82 | 82 | 82 | 82 | 82 |
| 7 | 83 | 83 | 83 | 83 | 83 |

A single binarization table is used regardless of the value of sps_cclm_enabled_flag as shown in Table 4.

TABLE 4
Unified binarization table for chroma prediction mode

| Value of | |
|---|---|
| intra_chroma_pred_mode | Bin string |
| 4 | 00 |
| 0 | 0100 |
| 1 | 0101 |
| 2 | 0110 |
| 3 | 0111 |
| 5 | 10 |
| 6 | 110 |
| 7 | 111 |

In Table 4, the first bin indicates whether it is regular (0) or CCLM modes (1). If it is LM mode, then the next bin indicates whether it is LM_LA (0) or not. If it is not LM_LA, next 1 bin indicates whether it is LM_L (0) or LM_A (1). For this case, when sps_cclm_enabled_flag is 0, the first bin of the binarization table for the corresponding intra_chroma_pred_mode can be discarded prior to the entropy coding. Or, in other words, the first bin is inferred to be 0 and hence not coded. This single binarization table is used for both sps_cclm_enabled_flag equal to 0 and 1 cases. The first two bins in Table 4 are context coded with its own context model, and the rest bins are bypass coded.

In addition, in order to reduce luma-chroma latency in dual tree, when the 64×64 luma coding tree node is partitioned with Not Split (and ISP is not used for the 64×64 CU) or QT, the chroma CUs in 32×32/32×16 chroma coding tree node are allowed to use CCLM in the following way:
If the 32×32 chroma node is not split or partitioned QT split, all chroma CUs in the 32×32 node can use CCLM
If the 32×32 chroma node is partitioned with Horizontal BT, and the 32×16 child node does not split or uses Vertical BT split, all chroma CUs in the 32×16 chroma node can use CCLM.

In all the other luma and chroma coding tree split conditions, CCLM is not allowed for chroma CU.

### Multiple Model CCLM (MMLM)

In the JEM (J. Chen, E. Alshina, G. J. Sullivan, J.-R. Ohm, and J. Boyce, Algorithm Description of Joint Exploration Test Model 7, document JVET-G1001, ITU-T/ISO/IEC Joint Video Exploration Team (JVET), July 2017), multiple model CCLM mode (MMLM) is proposed for using two models for predicting the chroma samples from the luma samples for the whole CU. In MMLM, neighbouring luma samples and neighbouring chroma samples of the current block are classified into two groups, each group is used as a training set to derive a linear model (i.e., a particular a and B are derived for a particular group). Furthermore, the samples of the current luma block are also classified based on the same rule for the classification of neighbouring luma samples.

FIG. 8 shows an example of classifying the neighbouring samples into two groups. Threshold is calculated as the average value of the neighbouring reconstructed luma samples. A neighbouring sample with Rec′L [x,y]<=Threshold is classified into group 1; while a neighbouring sample with Rec′L [x,y]>Threshold is classified into group 2.

$$\{ \begin{matrix}P r e {d}_{C} [ x , y ] = {α}_{1} \times Re {c}_{L}^{′} [ x , y ] + {β}_{1} & if Re {c}_{L}^{′} [ x , y ] \leq Threshold \\ P r e {d}_{C} [ x , y ] = {α}_{2} \times {Rec}_{L}^{′} [ x , y ] + {β}_{2} & if Re {c}_{L}^{′} [ x , y ] > Threshold\end{matrix} \qquad ( 8 )$$

### Convolutional Cross-Component Model (CCCM)

In CCCM, a convolutional model is applied to improve the chroma prediction performance. The convolutional model has 7-tap filter consist of a 5-tap plus sign shape spatial component, a nonlinear term and a bias term. The input to the spatial 5-tap component of the filter consists of a center (C) luma sample which is collocated with the chroma sample to be predicted and its above/north (N), below/south(S), left/west (W) and right/east (E) neighbours as illustrated in FIG. 9.

The nonlinear term (denoted as P) is represented as power of two of the center luma sample C and scaled to the sample value range of the content:

$$P = C ⋆ C + midVal >> bitDepth .$$

That is, for 10-bit content it is calculated as:

$$P = ( C ⋆ C + 512 ) >> 10$$

The bias term (denoted as B) represents a scalar offset between the input and output (similarly to the offset term in CCLM) and is set to middle chroma value (512 for 10-bit content).

Output of the filter is calculated as a convolution between the filter coefficients ci and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B$$

The filter coefficients ci are calculated by minimising MSE between predicted and reconstructed chroma samples in the reference area. FIG. 10 illustrates the reference area which consists of 6 lines of chroma samples above and left of the PU. Reference area extends one PU width to the right and one PU height below the PU boundaries. Area is adjusted to include only available samples. The extensions to the area shown in blue are needed to support the “side samples” of the plus shaped spatial filter and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

### Gradient Linear Model (GLM)

Compared with the CCLM, instead of down-sampled luma values, the GLM utilizes luma sample gradients to derive the linear model. Specifically, when the GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β$$

For signalling, when the CCLM mode is enabled for the current CU, two flags are signalled separately for Cb and Cr components to indicate whether GLM is enabled for each component; if the GLM is enabled for one component, one syntax element is further signalled to select one of 16 gradient filters (shown in FIG. 11) for the gradient calculation. The GLM can be combined with the existing CCLM by signalling one extra flag in bitstream. When such combination is applied, the filter coefficients that are used to derive the input luma samples of the linear model is calculated as the combination of the selected gradient filter of the GLM and the down-sampling filter of the CCLM.

### Cross-Component Prediction (CCP) Merge Mode

For chroma coding, a flag is signalled to indicate whether CCP mode (including the CCLM, CCCM, GLM and their variants) or non-CCP mode (conventional chroma intra prediction mode, fusion of chroma intra prediction mode) is used. If the CCP mode is selected, one more flag is signalled to indicate how to derive the CCP type and parameters, i.e., either from a CCP merge list or signalled/derived on-the-fly. a CCP merge candidate list is constructed from the spatial adjacent, temporal, spatial non-adjacent, history-based m or shifted temporal candidates. After including these candidates, default models are further included to fill the remaining empty positions in the merge list. In order to remove redundant CCP models in the list, pruning operation is applied. After constructing the list, the CCP models in the list are reordered depending on the SAD costs, which are obtained using the neighbouring template of the current block. More details are described below.

### Spatial Adjacent and Non-Adjacent Candidates

The positions and inclusion order of the spatial adjacent and non-adjacent candidates are the same as those defined in ECM for regular inter merge prediction candidates.

### Temporal and Shifted Temporal Candidates

Temporal candidates are selected from the collocated picture. The position and inclusion order of the temporal candidates are the same as those defined in ECM for regular inter merge prediction candidates. The shifted temporal candidates are also selected from the collocated picture. The position of temporal candidates is shifted by a selected motion vector which is derived from motion vectors of neighbouring blocks.

### History-Based Candidates

A history-based table is maintained to include the recently used CCP models, and the table is reset at the beginning of each CTU row. If the current list is not full after including spatial adjacent and non-adjacent candidates, the CCP models in the history-based table are added into the list.

### Default Candidates

CCLM candidates with default scaling parameters are considered, only when the list is not full after including the spatial adjacent, spatial non-adjacent, or history-based candidates. If the current list has no candidates with the single model CCLM mode, the default scaling parameters are {0, ⅛, −⅛, 2/8, − 2/8, ⅜, −⅜, 4/8, − 4/8, ⅝, −⅝, 6/8}. Otherwise, the default scaling parameters are {0, the scaling parameter of the first CCLM candidate+{⅛, −⅛, 2/8, − 2/8, ⅜, −⅜, 4/8, − 4/8, ⅝, −⅝, 6/8}}.

A flag is signalled to indicate whether the CCP merge mode is applied or not. If CCP merge mode is applied, an index is signalled to indicate which candidate model is used by the current block. In addition, CCP merge mode is not allowed for the current chroma coding block when the current CU is coded by intra sub-partitions (ISP) with single tree, or the current chroma coding block size is less than or equal to 16. In this disclosure, the “CCP mode” and “LM mode” are exchangeable notations.

In the present invention, methods and apparatus to improve the coding performance for video coding systems using an LM (Linear Model) mode are disclosed.

### BRIEF SUMMARY OF THE INVENTION

A method and apparatus for video coding are disclosed. According to this method, input data associated with a current block comprising a current first-colour block and a current second-colour block is received, wherein the input data comprise pixel data to be encoded at an encoder side or data associated with the current block to be decoded at a decoder side, and wherein the current second-colour block is coded in a cross-component Liner Model (LM)-related mode. A most probable LM mode list comprising one or more most probable LM candidates selected from a candidate list is generated. Mode-selection information associated with the most probable LM mode list is signalled or parsed. The current second-colour block is encoded or decoded by using a target candidate selected from the most probable LM mode list according to the mode-selection information, wherein prediction data for the current second-colour block is generated by applying current linear model associated with the target candidate to the current first-colour block.

In one embodiment, a first flag is signalled or parsed to indicate if a current LM mode is one candidate in the most probable LM mode list or not. In one embodiment, when the first flag is true, a candidate index for the target candidate of the most probable LM mode list is further signalled. In one embodiment, when the first flag is false, mode information related to the current LM mode is further implicitly or explicitly indicated. In one embodiment, the mode information comprises LM mode type, selection of single model or multiple models, model derivation pattern, or a combination thereof. In one embodiment, when the most probable LM mode list does not include all allowed LM modes of the current block and if the first flag is false, at least one LM mode candidate in the most probable LM mode list is set to be invalid or disallowed to be indicated. The LM model type includes CCLM, GLM, CCCM, GL-CCCM, NS-CCCM, MDF-CCCM or a combination thereof.

In one embodiment, the most probable LM mode list comprises one or more LM modes of one or more neighbouring coded blocks. In one embodiment, said one or more neighbouring coded blocks comprise one or more adjacent positions, one or more non-adjacent positions, or both. In one embodiment, said one or more LM modes of one or more neighbouring coded blocks are counted and then sorted in a non-descending order.

In one embodiment, the most probable LM mode list comprises one or more adjacent positions, one or more non-adjacent positions, one or more temporal positions, one or more historical positions, or a combination there of in a same CTU row or picture.

In one embodiment, the most probable LM mode list comprises one or more combined LM mode candidates, and wherein each combined LM mode candidate is generated by combining multiple allowed LM models for the current block. In one embodiment, the multiple allowed LM models for the current block correspond to different model derivation patterns, different selection among single model and multiple models, different LM mode types, or a combination thereof. In one embodiment, the most probable LM mode list further comprises one or more LM models from one or more previous coded blocks of the current block or from one or more previous coded pictures.

In one embodiment, the candidate list is reordered according to candidate indexes prior to candidate reordering. In one embodiment, when a maximum allowed size of the candidate list is N, first m LM candidates in the candidate list are not reordered and remaining (N−m) candidates are reordered, and wherein N and m are integers and 1≤m<N. In one embodiment, a second flag is used to indicate whether the candidate reordering is applied or not. In one embodiment, the candidate list is divided or classified into k groups and the candidate reordering is applied to each group respectively, and wherein k is a positive integer and k>1.

In one embodiment, the candidate list is divided or classified according to model type, being single model or multiple models, spatial candidate types, temporal candidate types, history candidate types, default candidate types, spatial geometric distance, temporal POC (Picture Order Count) distance between a corresponding candidate position and the current block, or a combination thereof. In one embodiment, after reordering each group, the candidate list is further reordered at a group level to reorder positions of the k groups. In one embodiment, the candidate list is further reordered according to minimal cost, average cost, medium cost, or maximum cost associated with candidates in each group.

In one embodiment, a third flag is used to indicate whether the candidate list is in an inverse order.

### BRIEF DESCRIPTION OF THE DRAWINGS

FIG. 1A illustrates an exemplary adaptive Inter/Intra video encoding system incorporating loop processing.

FIG. 1B illustrates a corresponding decoder for the encoder in FIG. 1A.

FIG. 2 illustrates examples of a multi-type tree structure corresponding to vertical binary splitting (SPLIT_BT_VER), horizontal binary splitting (SPLIT_BT_HOR), vertical ternary splitting (SPLIT_TT_VER), and horizontal ternary splitting (SPLIT_TT_HOR).

FIG. 3 illustrates an example of the signalling mechanism of the partition splitting information in quadtree with nested multi-type tree coding tree structure.

FIG. 4 shows an example of a CTU divided into multiple CUs with a quadtree and nested multi-type tree coding block structure, where the bold block edges represent quadtree partitioning and the remaining edges represent multi-type tree partitioning.

FIG. 5 shows the 67 intra prediction modes as adopted by the VVC video coding standard.

FIGS. 6A-B illustrate examples of wide-angle intra prediction a block with width larger than height (FIG. 6A) and a block with height larger than width (FIG. 6B).

FIG. 7 shows an example of the location of the left and above samples and the sample of the current block involved in the LM_LA mode.

FIG. 8 shows an example of classifying the neighbouring samples into two groups according to multiple mode CCLM.

FIG. 9 illustrates an example of spatial part of the convolutional filter.

FIG. 10 illustrates an example of reference area with paddings used to derive the filter coefficients.

FIG. 11 illustrates the 16 gradient patterns for Gradient Linear Model (GLM).

FIG. 12A and FIG. 12B illustrate examples of non-adjacent spatial positions for counting the neighbouring LM modes for pattern 1 (FIG. 12A) and pattern 2 (FIG. 12B).

FIG. 13 illustrates a flowchart of an exemplary video coding system that incorporates most probable LM mode list according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

The following methods are proposed to improve the cross-component prediction accuracy or coding performance:

### Signalling the Inherited Candidate Index in the List

In one embodiment, an on/off flag is signalled to indicate if the current block inherits the cross-component model parameters from neighbouring blocks or not. The flag can be signalled per CU/CB, per PU, per TU/TB, per colour component, or per chroma colour component. A high-level syntax can be signalled in SPS, PPS, PH or SH to indicate if the proposed method is allowed for the current sequence, picture, or slice.

If the current block inherits the cross-component model parameters from neighbouring blocks, the inherited candidate index is signalled. The index can be signalled (e.g., using truncate unary code, Exp-Golomb code, or fixed length code) and shared among both the current Cb and Cr blocks. For another example, the index can be signalled per colour component. For example, one inherited index is signalled for Cb component, and another inherited index is signalled for Cr component. For another example, it can use chroma intra prediction syntax (e.g., IntraPredModeC[xCb][yCb]) to store the inherited index.

For another example, if the inherited candidate index has larger index value, the index is signalled by using truncate unary code and truncate unary code. To reduce the average codeword length (e.g. Table 5), assume the maximum allowed list size is 12, the index 8 to 11 can be signalled in truncated unary with truncated binary, and the truncated binary size is 2. In another example, the index 4 to 11 can be signalled in truncated unary with truncated binary, and the truncated binary size is 3. In yet another example, the index can be signalled in the following modified exp-Golomb codes.

TABLE 5
Examples of codeword design for candidate index

| | | Truncated Unary + | | |
|---|---|---|---|---|
| | | Truncated Binary | | |
| | | Truncated | Truncated | Modified |
| | Truncated | Binary | Binary | Exp- |
| Index | Unary | Size = 2 | size = 3 | Golomb |
| 0 | 0 | 0 | 0 | 1 |
| 1 | 10 | 10 | 10 | 010 |
| 2 | 110 | 110 | 110 | 011 |
| 3 | 1110 | 1110 | 1110 | 00100 |
| 4 | 11110 | 11110 | 1111 000 | 00101 |
| 5 | 111110 | 111110 | 1111 001 | 00110 |
| 6 | 1111110 | 1111110 | 1111 010 | 00111 |
| 7 | 11111110 | 11111110 | 1111 011 | 000100 |
| 8 | 111111110 | 11111111 00 | 1111 100 | 000101 |
| 9 | 1111111110 | 11111111 01 | 1111 101 | 000110 |
| 10 | 11111111110 | 11111111 10 | 1111 110 | 000111 0 |
| 11 | 11111111111 | 11111111 11 | 1111 111 | 000111 1 |

If the current block inherits the cross-component model parameters from neighbouring blocks, the current chroma intra prediction mode (e.g., IntraPredModeC[xCb][yCb] as defined in VVC standard) is temporally set to a cross-component mode (e.g., CCLM_LT) at the bitstream syntax parsing stage. Later, at the prediction stage or reconstruction stage, the candidate list is derived, and the inherited candidate model is then determined by the inherited candidate index. After obtaining the inherited model, the coding information of the current block is then updated according to the inherited candidate model. The coding information of the current block includes, but not limited to, the prediction mode (e.g., CCLM_LT or MMLM_LT), related sub-mode flags (e.g., CCCM mode flag), prediction pattern (e.g., GLM pattern index), and the current model parameters. Then, the prediction of the current block is generated according to the updated coding information.

In another embodiment, the inherited candidate index can be signalled by selecting the target group first and then choosing the index in the selected group. For example, all candidates can be separated into N groups (N>1). To signal the inherited candidate index, the group ID is signalled first to indicate which group contains the inherited candidate index, and then the index in the group is further signalled to indicate the final inherited candidate. For example, the grouping rule can depend on LM model type (e.g., CCLM, GLM, CCCM, GL-CCCM, NS-CCCM, or MDF-CCCM), single model or multiple models, or spatial/temporal/history/default candidate types.

### Reordering the Candidates in the List

The candidates in the CCP merge list can be reordered to reduce the syntax overhead when signalling the selected candidate index. The reordering rules can depend on the coding information of neighbouring blocks or the model error. For example, if neighbouring above or left blocks are coded by MMLM, the MMLM candidates in the list can be moved to the head of the current list. Similarly, if neighbouring above or left blocks are coded by single model LM or CCCM, the single model LM or CCCM candidates in the list can be moved to the head of the current list. Similarly, if GLM is used by neighbouring above or left blocks, the GLM related candidates in the list can be moved to the head of the current list.

In still another embodiment, the reordering rule is based on the model error by applying the candidate model to the neighbouring templates of the current block, and then compare the error with the reconstruction samples of the neighbouring template.

The reordering rules can also depend on the candidate index before doing reordering. For example, if the maximum allowed list size is N, the first m candidates in the list are not reordered, where 1≤m<N. In other words, list reordering is applied to the rest (N−m) candidates. In one embodiment, an additional flag is used to indicate if the list reordering is applied or not.

In another embodiment, the current list is divided or classified into k groups, (e.g., according to model type, single model or multiple models, spatial/temporal/history/default candidate types, or the spatial geometric distance or temporal POC distance between the inherited candidate position and the current block), the list reordering is applied to each group respectively. In another embodiment, after reordering each group, another reordering is applied at group level to reorder the positions of each group (e.g., according to the minimal/average/medium/maximum cost of the candidates in each group).

In another embodiment, a flag is used to indicated if the list is in an inverse order. If the flag is true, the final candidate index is the maximum allowed list size minus the signalled index value. For example, the list in the inverse order can be the list before or after applying list reordering. For another example, the inverse list order is only applied to partial candidate indices in the list.

### Signalling for LM Related Modes

If the current chroma prediction mode is LM related mode, when signalling the LM related mode used for the current block, a most probable LM mode list is created. A flag is signalled to indicate if the current LM mode is one of the candidates in the most probable LM mode list or not. If the flag is true, the target candidate index of the mode list is further signalled. Otherwise (i.e., the flag is false), the LM mode type (e.g., CCLM, GLM, CCCM, GL-CCCM, NS-CCCM, or MDF-CCCM), the selection of single model or multiple models, and/or the model derivation pattern (e.g., left-only, top-only, or left and top neighbouring samples to derive model) are further implicitly or explicitly indicated. When the most probable LM mode list does not include all allowed LM modes of the current blocks, to avoid signalling redundancy, at least one of the LM models in the mode list is invalid or disallowed to be indicated if the flag is false. In other words, if the number of all allowed LM modes is m, and the number of candidates in the most probable LM mode list is n, when n<m, at least one of the LM models in the mode list is invalid or disallowed to be indicated. Otherwise, when n and m are equal, the avoiding signalling redundancy rule is not applied.

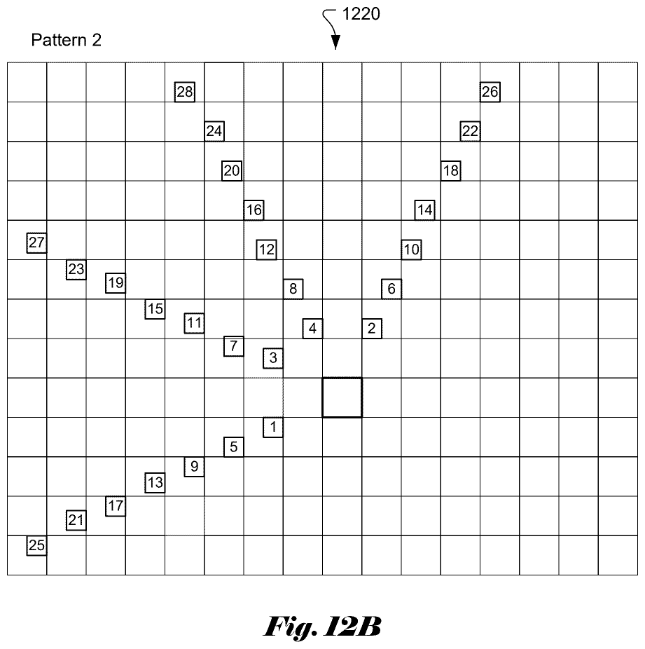

In one embodiment, the most probable LM mode list can be created based on the LM modes of the neighbouring coded blocks. For example, the LM modes selected by neighbouring spatial adjacent and non-adjacent positions are counted and then sorted in non-descending order to create the mode list. For still the same example, the non-adjacent positions can be as the pattern depicted in FIG. 12A and FIG. 12B, where the distance between each position is the width and height of current coding block. In another embodiment, the distance between the positions that are closer to the current encoding block is shorten than the positions that are further away from the current block. For still the same example, if there are N selection patterns, the first selection pattern is used first to count LM modes, then the second selection pattern, . . . , and then the N-th selection pattern. FIG. 12A and FIG. 12B illustrate an example for N=2. For another example, the most probable LM mode list can be created based on the LM modes of the previous coded blocks in the same CTU, CTU row, or picture. For another example, the LM modes selected by neighbouring spatial adjacent, non-adjacent, temporal, historical positions in the same CTU, CTU row, or picture are counted and then sorted in a non-descending order to create the mode list.

In another embodiment, the mode list can contain many combinations of allowed LM models for the current block, these LM models can be derived by using different model derivation patterns, has single model or multiple models, and various LM mode types. Then, the model errors over the neighbouring template area are calculated between the predictions (i.e., generated by the combinations of the mode list) and the neighbouring reconstructions. The mode list is reordered according to the model error of each combination. The first k combinations with the least model error are selected and one of the k combinations is determined as the final LM mode for the current block. For example, the combination with the lowest model error is selected as the final LM mode for the current block. For another example, when calculating the model error, different weighting factor can be applied to each combination according to the LM mode type, model derivation pattern, or single model or multiple models of the combination. For still another example, when calculating the model error of combinations, convolutional model has lower weighting factor than 2-parameter LM models. For still another example, when calculating the model error, single model has lower weighting factor than multiple models.

In another embodiment, the mode list can contain many combinations of allowed LM models for the current block, and also contain the LM models from previous coded blocks in the current or previous coded pictures. Similarly, a flag is used to indicate if the current LM mode is one of the first k combinations with the least model error. If the flag is true, one of the k combinations is implicitly or explicitly determined as the final LM mode for the current block. Otherwise (i.e., the flag is false), the CCP merge mode flag, the LM mode type, the selection of single model or multiple models, and/or the model derivation pattern of the current LM mode is further indicated. To avoid signalling redundancy, at least one of the LM models in the mode list is invalid or disallowed to be indicated if the flag is false. In other words, if number of all allowed LM modes is m, and the number of candidates in the most probable LM mode list is n, when n<m, at least one of the LM models in the mode list is invalid or disallowed to be indicated. Otherwise, when n and m are equal, the avoiding signalling redundancy rule is not used. For another example, when calculating the model error, the LM models from previous coded blocks have lower weighting factor than LM models derived using neighbouring reconstruction samples. For still another example, when calculating the model error, the LM models from previous coded blocks have higher weighting factor than LM models derived using neighbouring reconstruction samples. For another example, the previous coded blocks can come from the blocks in the same CTU, CTU row, or picture.

In another embodiment, when CCP merge mode is used, a default candidate can be a shortcut to indicate a cross-component mode (i.e., to use the current neighbouring luma/chroma reconstruction samples to derive cross-component models) rather than inheriting parameters from neighbours. For example, the default candidates can be at least one of CCLM, GLM, CCCM, GL-CCCM, NS-CCCM, or MDF-CCCM derived using the current neighbouring samples. For another example, k default candidates are implicitly determined from allowed LM models for the current block. The model error over the neighbouring template area is calculated between the predictions (i.e., generated by the allowed LM models) and the neighbouring reconstructions. The k default candidates with the lowest model error are determined and added into the CCP merge list.

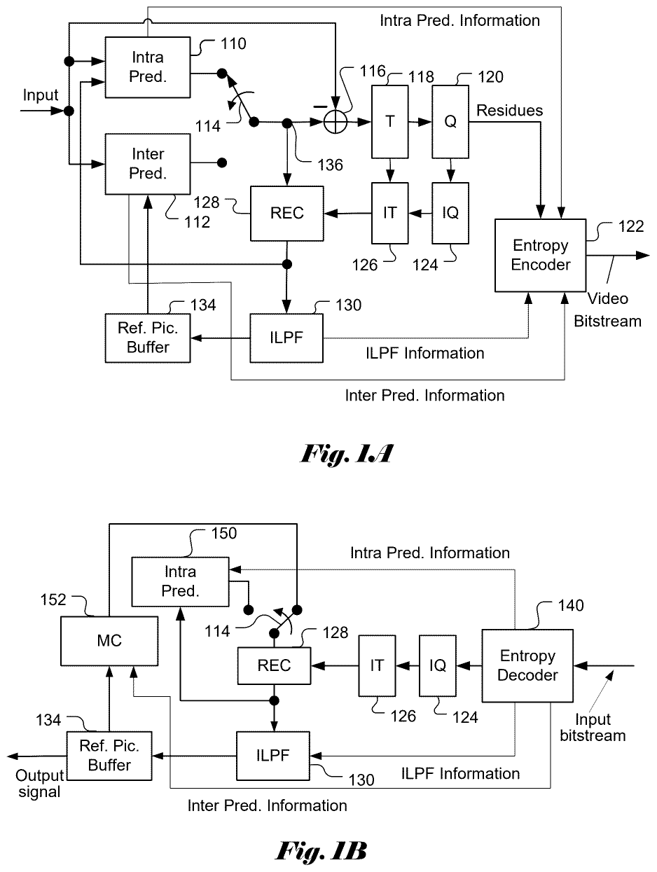

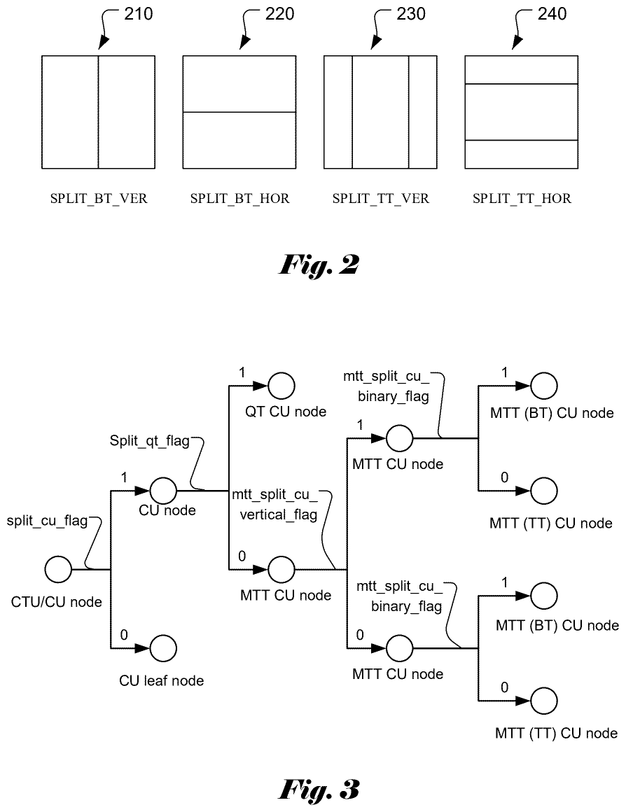

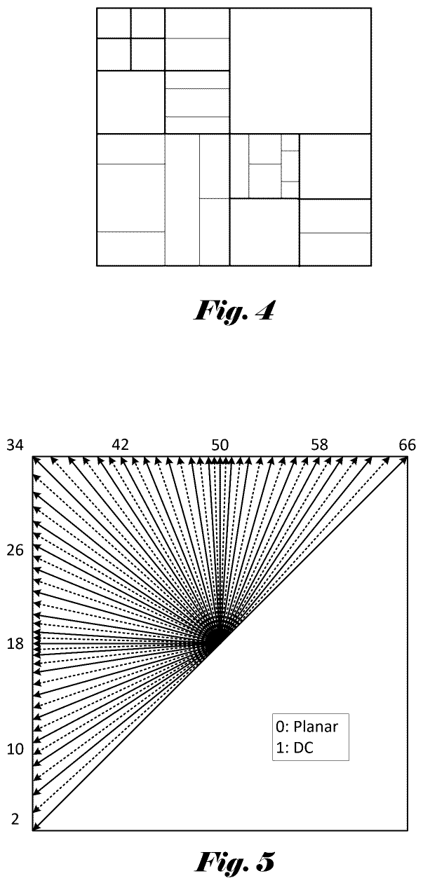

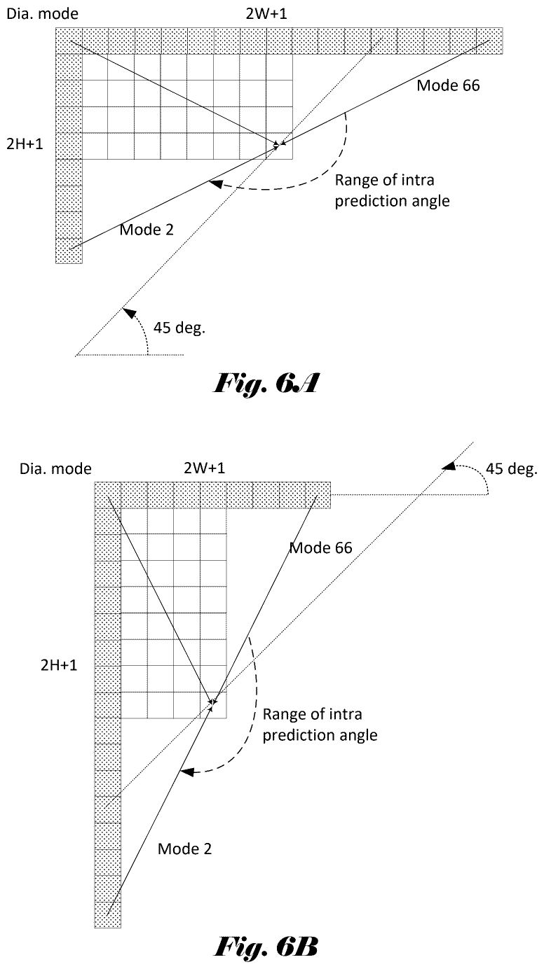

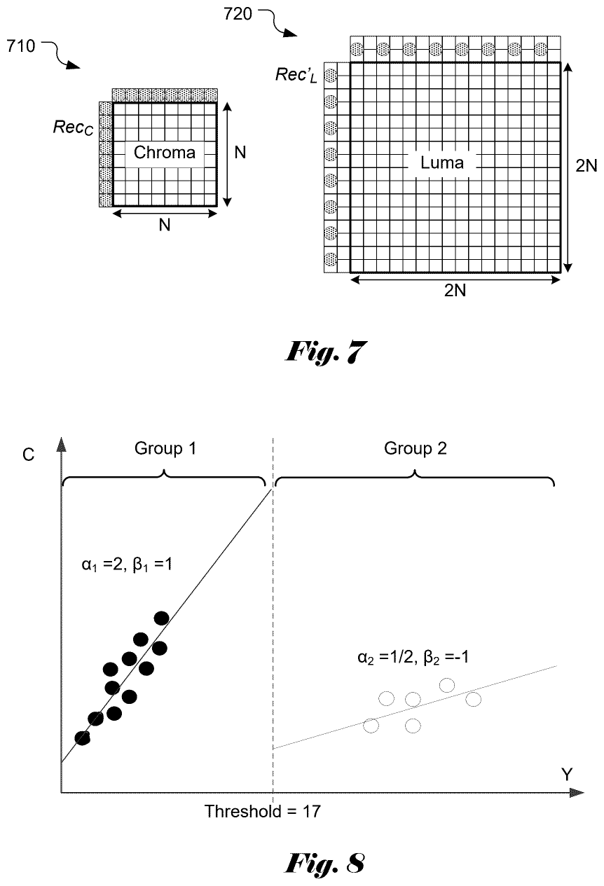

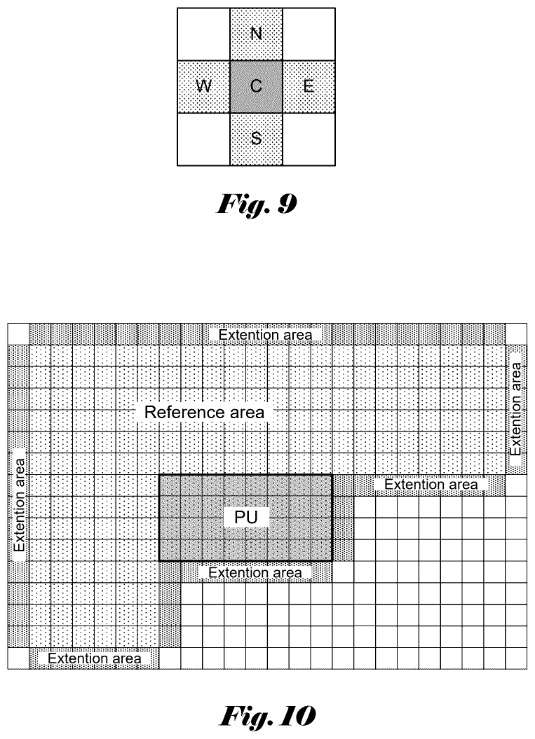

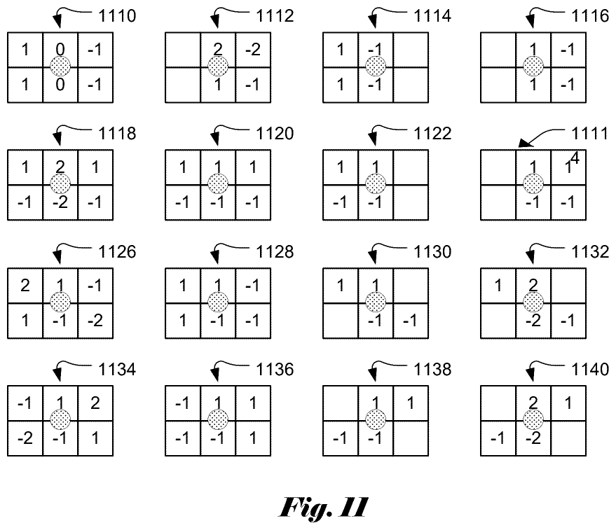

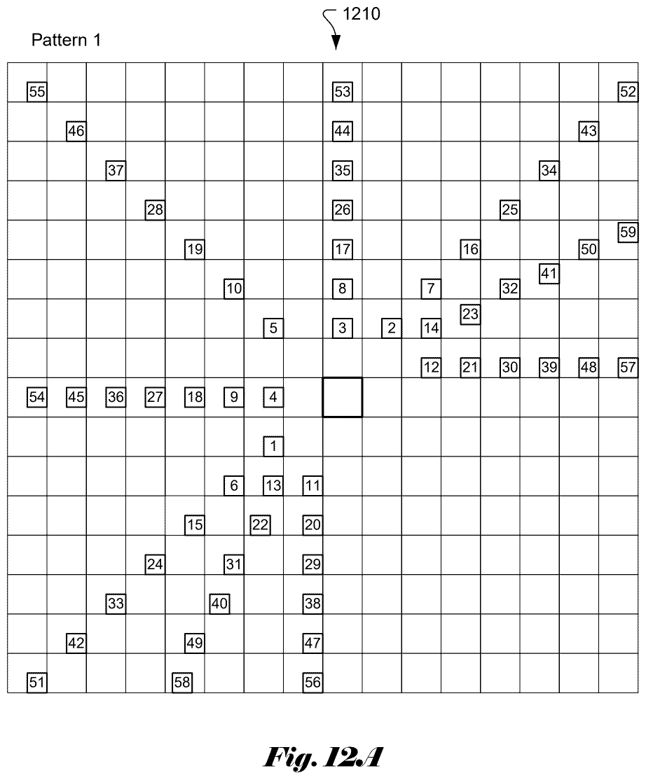

Any of the foregoing proposed methods of using most probable LM candidate list can be implemented in encoders and/or decoders. For example, any of the proposed methods of using most probable LM candidate list can be implemented in an inter/intra/prediction module of an encoder, and/or an inter/intra/prediction module of a decoder. Alternatively, any of the proposed methods can be implemented as a circuit coupled to the inter/intra/prediction module of the encoder and/or the inter/intra/prediction module of the decoder, so as to provide the information needed by the inter/intra/prediction module. With reference to the encoder and decoder in FIG. 1A and FIG. 1B, any of the proposed methods of using most probable LM candidate list can be implemented in an inter/intra/prediction/transform module (e.g. Intra Pred. 110 in FIG. 1A) of an encoder, and/or an inter/intra/prediction/transform module (e.g. Intra Pred. 150 in FIG. 1B) of a decoder.

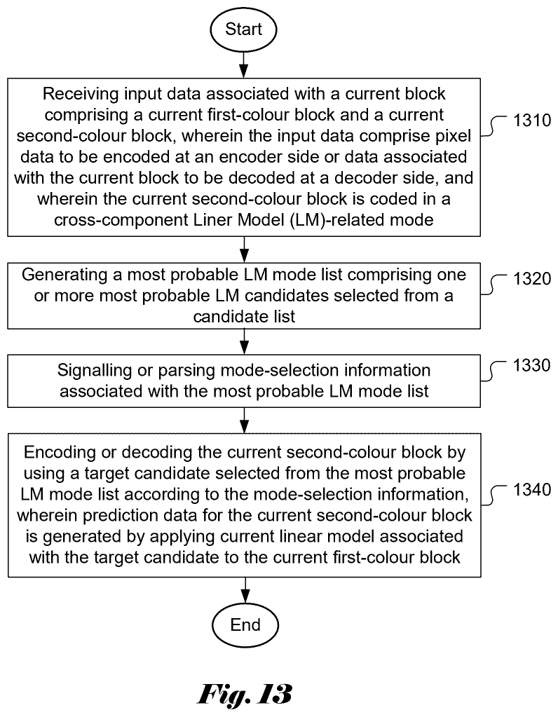

FIG. 13 illustrates a flowchart of an exemplary video coding system that incorporates most probable LM mode list according to an embodiment of the present invention. The steps shown in the flowchart may be implemented as program codes executable on one or more processors (e.g., one or more CPUs) at the encoder side and/or decoder side. The steps shown in the flowchart may also be implemented based hardware such as one or more electronic devices or processors arranged to perform the steps in the flowchart. According to this method, input data associated with a current block comprising a current first-colour block and a current second-colour block is received in step 1310, wherein the input data comprise pixel data to be encoded at an encoder side or data associated with the current block to be decoded at a decoder side, and wherein the current second-colour block is coded in a cross-component Liner Model (LM)-related mode. A most probable LM mode list comprising one or more most probable LM candidates selected from a candidate list is generated in step 1320. Mode-selection information associated with the most probable LM mode list is signalled or parsed in step 1330. The current second-colour block is encoded or decoded by using a target candidate selected from the most probable LM mode list according to the mode-selection information in step 1340, wherein prediction data for the current second-colour block is generated by applying current linear model associated with the target candidate to the current first-colour block.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block comprising a current first-colour block and a current second-colour block, wherein the input data comprise pixel data to be encoded at an encoder side or data associated with the current block to be decoded at a decoder side, and wherein the current second-colour block is coded in a cross-component Liner Model (LM)-related mode;
generating a most probable LM mode list comprising one or more most probable LM candidates selected from a candidate list;
signalling or parsing mode-selection information associated with the most probable LM mode list; and
encoding or decoding the current second-colour block by using a target candidate selected from the most probable LM mode list according to the mode-selection information, wherein prediction data for the current second-colour block is generated by applying current linear model associated with the target candidate to the current first-colour block.

2. The method of claim 1, wherein a first flag is signalled or parsed to indicate if a current LM mode is one candidate in the most probable LM mode list or not.

3. The method of claim 2, wherein when the first flag is true, a candidate index for the target candidate of the most probable LM mode list is further signalled.

4. The method of claim 2, wherein when the first flag is false, mode information related to the current LM mode is further implicitly or explicitly indicated.

5. The method of claim 4, wherein the mode information comprises LM mode type, selection of single model or multiple models, model derivation pattern, or a combination thereof.

6. The method of claim 2, wherein when the most probable LM mode list does not include all allowed LM modes of the current block and if the first flag is false, at least one LM mode candidate in the most probable LM mode list is set to be invalid or disallowed to be indicated.

7. The method of claim 1, wherein the most probable LM mode list comprises one or more LM modes of one or more neighbouring coded blocks.

8. The method of claim 7, wherein said one or more neighbouring coded blocks comprise one or more adjacent positions, one or more non-adjacent positions, or both.

9. The method of claim 7, wherein said one or more LM modes of one or more neighbouring coded blocks are counted and then sorted in a non-descending order.

10. The method of claim 1, wherein the most probable LM mode list comprises one or more adjacent positions, one or more non-adjacent positions, one or more temporal positions, one or more historical positions, or a combination there of in a same CTU row or picture.

11. The method of claim 1, wherein the most probable LM mode list comprises one or more combined LM mode candidates, and wherein each combined LM mode candidate is generated by combining multiple allowed LM models for the current block.

12. The method of claim 11, wherein the multiple allowed LM models for the current block correspond to different model derivation patterns, different selection among single model and multiple models, different LM mode types, or a combination thereof.

13. The method of claim 11, wherein the most probable LM mode list further comprises one or more LM models from one or more previous coded blocks of the current block or from one or more previous coded pictures.

14. The method of claim 1, wherein the candidate list is reordered according to candidate indexes prior to candidate reordering.

15. The method of claim 14, wherein when a maximum allowed size of the candidate list is N, first m LM candidates in the candidate list are not reordered and remaining (N−m) candidates are reordered, and wherein N and m are integers and 1≤m<N.

16. The method of claim 14, wherein a second flag is used to indicate whether the candidate reordering is applied or not, and a third flag is used to indicate whether the candidate list is in an inverse order.

17. The method of claim 14, wherein the candidate list is divided or classified into k groups and the candidate reordering is applied to each group respectively, and wherein k is a positive integer and k>1.

18. The method of claim 17, wherein the candidate list is divided or classified according to model type, being single model or multiple models, spatial candidate types, temporal candidate types, history candidate types, default candidate types, spatial geometric distance, temporal POC (Picture Order Count) distance between a corresponding candidate position and the current block, or a combination thereof.

19. The method of claim 17, wherein after reordering each group, the candidate list is further reordered at a group level to reorder positions of the k groups, wherein the candidate list is further reordered according to minimal cost, average cost, medium cost, or maximum cost associated with candidates in each group.

20. An apparatus for video coding, the apparatus comprising one or more electronics or processors arranged to:
receive input data associated with a current block comprising a current first-colour block and a current second-colour block, wherein the input data comprise pixel data to be encoded at an encoder side or data associated with the current block to be decoded at a decoder side, and wherein the current second-colour block is coded in a cross-component Liner Model (LM)-related mode;
generate a most probable LM mode list comprising one or more most probable LM candidates selected from a candidate list;
signal or parse mode-selection information associated with the most probable LM mode list; and
encode or decode the current second-colour block by using a target candidate selected from the most probable LM mode list according to the mode-selection information, wherein prediction data for the current second-colour block is generated by applying current linear model associated with the target candidate to the current first-colour block.
